(19) United States
(12) Patent Application Publication
(10) Pub. No.: US 2024/0339056 A1
(43) Pub. Date: Oct. 10, 2024

(54) NUMBER DISPLAY SYSTEM, REGISTRATION DEVICE, TEMPORARY SEAT DESIGNATION DISPLAY DEVICE, NUMBER DISPLAY METHOD, AND PROGRAM

(71) Applicant: NIPPON TELEGRAPH AND TELEPHONE CORPORATION, Tokyo (JP)

(72) Inventor: Nobuhiro HIRACHI, Tokyo (JP)

(73) Assignee: NIPPON TELEGRAPH AND TELEPHONE CORPORATION, Tokyo (JP)

(21) Appl. No.: 18/578,642

(22) PCT Filed: Jul. 13, 2021
(86) PCT No.: PCT/JP2021/026369

§ 371 Date: Jan. 11, 2024

(51) Int. Cl. G09G 3/00

(52) U.S. Cl. CPC G09G 3/001

(57) ABSTRACT

A number display system (1) according to the present invention includes: a registration device (10) that inputs temporary seat information that includes temporary seat installation position information indicating positions where temporary seats are installed, information regarding temporary seat numbers to be displayed on the temporary seats, and temporary seat layout information indicating layout of the temporary seats, and transmits the temporary seat information and search information for searching for the temporary seat information; a temporary seat information server (30) that registers the temporary seat information transmitted from the registration device (10) in a temporary seat information DB (31), searches the temporary seat information DB (31) on the basis of the search information transmitted from the registration device (10), acquires the temporary seat information matching the search information, and transmits the temporary seat information to the registration device (10); and a temporary seat designation display device (20) that optically projects the temporary seat numbers onto the temporary seats on the basis of the temporary seat information transmitted from the registration device (10).

### TECHNICAL FIELD

The present invention relates to a number display system, a registration device, a temporary seat designation display device, a number display method, and a program.

### BACKGROUND ART

In a facility in which seats are fixedly installed, such as a concert hall or an event facility, the seats and seat numbers are fixed, and each organizer individually manages the seats in a conventional situation. However, in a case where an event is temporarily held in a temporary facility such as a gymnastic hall, an event space, or an outdoor space where seats are not fixedly installed, temporary seats (the seats refer to places or spaces for sitting) are installed. In such a case, it is necessary to perform labeling work, in which a seat number is assigned to each seat and a label on which the seat number is printed is affixed to each seat.

Patent Literature 1 describes a seat guidance apparatus that, in a case where a customer is waiting to be guided to a desired seat in a store such as a restaurant, performs authentication of the customer to be guided to the seat when the seat is ready for the customer to be guided, and guides the customer to the desired seat.

### CITATION LIST

### Patent Literature

Patent Literature 1: JP 2017-224093 A

### SUMMARY OF INVENTION

### Technical Problem

In a case where temporary seats are installed in a temporary facility, an organizer performs labeling work, in which a label with a seat number printed in advance is affixed to each seat. However, in a case of increasing the number of seats just before the event, it is difficult for the organizer to flexibly perform the labeling work. Thus, in a case of displaying seat numbers on temporary seats, it is desired to eliminate such labeling work. Furthermore, it is required to flexibly and immediately respond to layout of seats or an increase or decrease in the number of seats.

An object of the present invention made in view of such circumstances is to provide a number display system, a registration device, a temporary seat designation display device, a number display method, and a program that flexibly and immediately respond to layout of seats or an increase or decrease in the number of seats by optically displaying seat numbers on temporary seats.

### Solution to Problem

In order to solve the above problems, an embodiment provides a number display system that optically displays temporary seat numbers on temporary seats, the number display system including: a registration device that inputs temporary seat information that includes temporary seat installation position information indicating positions where the temporary seats are installed, information regarding the temporary seat numbers to be displayed on the temporary seats, and temporary seat layout information indicating layout of the temporary seats, and transmits the temporary seat information and search information for searching for the temporary seat information; a temporary seat information server that registers the temporary seat information transmitted from the registration device in a temporary seat information DB, searches the temporary seat information DB on the basis of the search information transmitted from the registration device, acquires the temporary seat information matching the search information, and transmits the temporary seat information to the registration device; and a temporary seat designation display device that optically projects the temporary seat numbers onto the temporary seats on the basis of the temporary seat information transmitted from the registration device.

In order to solve the above problems, the embodiment provides a number display method for optically displaying temporary seat numbers on temporary seats, the number display method including: by a registration device, a step of inputting temporary seat information that includes temporary seat installation position information indicating positions where the temporary seats are installed, information regarding the temporary seat numbers to be displayed on the temporary seats, and temporary seat layout information indicating layout of the temporary seats; and a step of transmitting the temporary seat information or search information for searching for the temporary seat information; by a temporary seat information server, a step of registering the temporary seat information transmitted from the registration device in a temporary seat information DB; and a step of searching the temporary seat information DB on the basis of the search information transmitted from the registration device, acquiring the temporary seat information matching the search information, and transmitting the temporary seat information to the registration device; and by a temporary seat designation display device, a step of optically projecting the temporary seat numbers onto the temporary seats on the basis of the temporary seat information transmitted from the registration device.

In order to solve the above problems, a program according to the embodiment causes a computer to function as the above-described registration device.

### Advantageous Effects of Invention

According to the present invention, seat numbers are assigned and displayed on temporary seats remotely via a telecommunication line, and this makes it possible to flexibly and immediately respond to layout of seats or an increase or decrease in the number of seats.

### BRIEF DESCRIPTION OF DRAWINGS

FIG. 1 is a block diagram illustrating a configuration example of a number display system according to an embodiment.

FIG. 2 is a block diagram illustrating a configuration example of a registration device according to the embodiment.

FIG. 3 is a block diagram illustrating a configuration example of a temporary seat designation display device according to the embodiment.

FIG. 4A is a schematic diagram illustrating, from an upward direction, a positional relationship between a display unit of the temporary seat designation display device and installed temporary seats.

FIG. 4B is a schematic diagram illustrating, from a lateral direction, the positional relationship between the display unit of the temporary seat designation display device and the installed temporary seats.

FIG. 5 is a block diagram illustrating a configuration example of the registration device according to the embodiment and a temporary seat information server.

FIG. 6 is a sequence diagram illustrating an example of a number display method executed by the number display system according to the embodiment.

FIG. 7 is a block diagram illustrating a schematic configuration of a computer that functions as the registration device or the temporary seat designation display device.

### DESCRIPTION OF EMBODIMENTS

Hereinafter, a mode for carrying out the present invention will be described in detail with reference to the drawings.

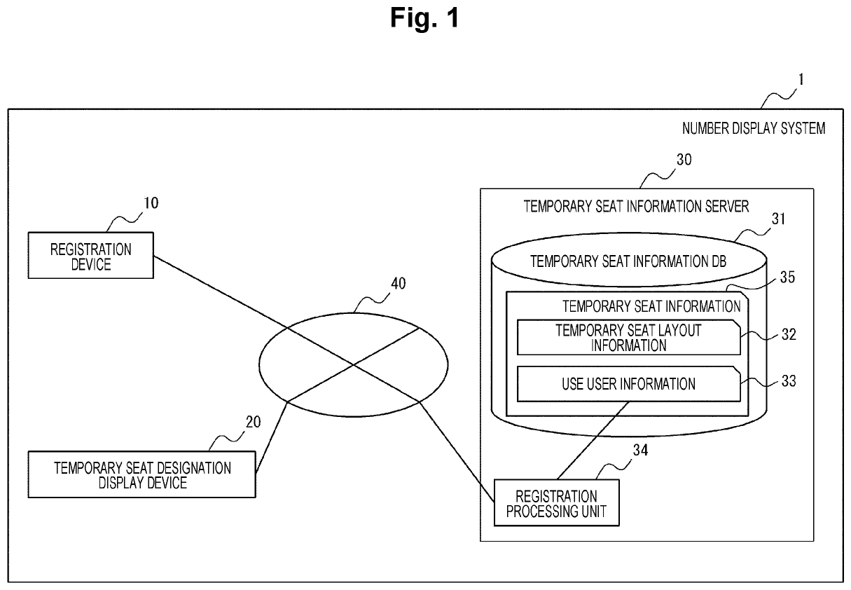

FIG. 1 is a block diagram illustrating a configuration example of a number display system 1 according to an embodiment. The number display system 1 illustrated in FIG. 1 includes a registration device 10, a temporary seat designation display device 20, and a temporary seat information server 30. The number display system 1 optically displays a temporary seat number on a temporary seat. The registration device 10, the temporary seat designation display device 20, and the temporary seat information server 30 can be connected to a telecommunication line 40 in a wired or wireless manner. The telecommunication line (network) 40, which is described as the Internet in the present embodiment, is not limited to the Internet, and may be another public network or a local area network (LAN).

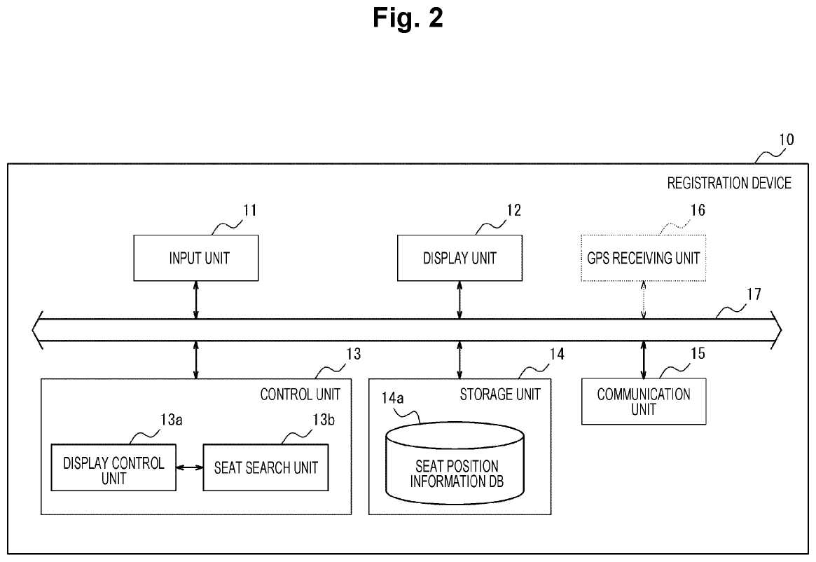

FIG. 2 is a block diagram illustrating a configuration example of the registration device 10 according to the embodiment. The registration device 10 includes an input unit 11, a display unit 12, a control unit 13, a storage unit 14, and a communication unit 15. These functional units are connected and controlled by a bus 17.

The input unit 11 is an input interface that receives a user's operation for inputting temporary seat layout information 32 that includes temporary seat installation position information (e.g., information of the positions of the temporary seats, installation addresses of the temporary seats, and the name of the facility where the temporary seats are installed) indicating the positions where the temporary seats are installed, information regarding temporary seat numbers to be displayed on the temporary seats, and temporary seat layout information indicating layout of the temporary seats (seat map). The temporary seat layout information 32 may further include a registration date, an equipment drawing, and the like. In addition, the input unit 11 inputs use user information 33 regarding a user who manages the temporary seat layout information 32. Hereinafter, the temporary seat layout information 32 and the use user information 33 are collectively referred to as temporary seat information 35 or simply as temporary seat information. The input unit 11 may be a touch panel integrated with a display device, a voice input device, or the like. Another example of the input unit 11 may be an existing input device such as a keyboard, a pointing device, a mouse, a tablet, or a button.

The display unit 12 displays the temporary seat information described above. The display unit 12 is, for example, a liquid crystal display device or an organic electro luminescence (EL) display device.

The control unit 13 includes a display control unit 13a that performs temporary seat display control on the display unit 12, and a seat search unit 13b that identifies temporary seat positions on the basis of the information regarding the temporary seat numbers input via the input unit 11. The control unit 13 is a central processing unit (CPU) or the like.

The storage unit 14 includes a seat position information DB 14a that stores, as seat position information, the temporary seat positions identified by the seat search unit 13b. The storage unit 14 is a volatile or non-volatile memory or the like including an auxiliary storage device such as a magnetic hard disk or a semiconductor storage device.

The communication unit 15 enables connection to an external device via the telecommunication line 40 in a wireless or wired manner. The communication unit 15 transmits, to the temporary seat information server 30, the temporary seat information 35 and search information for searching for the temporary seat information 35, and receives the temporary seat information 35 matching the search information. The communication unit 15 is a device for enabling connection to the telecommunication line 40 by wireless communication such as Wi-Fi, Bluetooth (registered trademark), or LTE, and performs processing of a communication protocol.

The registration device 10 stores, in the storage unit 14 in a non-volatile manner, temporary seat information input to the input unit 11. For registration of the temporary seat information input to the input unit 11, the registration device 10 transmits the temporary seat information to the temporary seat information server 30. The registration device 10 transmits search information for searching for the temporary seat information to the temporary seat information server 30, searches for the temporary seat information registered in a temporary seat information DB 31, and acquires the temporary seat information matching a search condition. Furthermore, the registration device 10 transmits, to the temporary seat designation display device 20, the temporary seat information transmitted from the temporary seat information server 30 so that the temporary seat numbers are optically projected onto the temporary seats. Information is transmitted and received between the registration device 10 and the temporary seat information server 30 or the temporary seat designation display device 20 via the telecommunication line 40.

The registration device 10 may further include a global positioning system (GPS) receiving unit 16 for satellite positioning of the positions where the temporary seats are installed.

The registration device 10 is described as a mobile terminal, such as a smartphone or a tablet, connectable to a telecommunication line such as the Internet or a LAN, but is not limited thereto. For example, the registration device 10 may be a terminal device in another form such as a notebook PC or a desktop PC.

Referring again to FIG. 1, the temporary seat information server 30 includes the temporary seat information DB 31 and a registration processing unit 34. The temporary seat information server 30 can be connected to the telecommunication line 40 in a wired or wireless manner.

The temporary seat information server 30 registers the temporary seat information 35 transmitted from the registration device 10 in the temporary seat information DB 31, searches the temporary seat information DB 31 on the basis of the search information transmitted from the registration device 10, acquires the temporary seat information 35 matching the search information, and transmits the temporary seat information 35 to the registration device 10.

The temporary seat information DB 31 stores the temporary seat information 35 in a non-volatile manner.

The registration processing unit 34 registers, modifies, or deletes the temporary seat information 35 in response to a request from the registration device 10, and also performs processing of searching for the temporary seat information 35 on the basis of the search information sent from the registration device 10 and transmitting the temporary seat information 35 matching the search information to the registration device 10, for example.

The temporary seat information DB 31 accumulates the temporary seat layout information 32 and the use user information 33, which constitute the temporary seat information 35, in association with each other. The use user information 33 is managed so as to include, for each piece of temporary seat information, a company name and address information, and also information such as a department name, a personal name, a telephone number, and an e-mail address. The use user information 33 may accumulate images of the temporary seat layout information itself. In the temporary seat layout information 32, the “installation addresses of the temporary seats”, the “name of the facility where the temporary seats are installed”, and the “information of the positions of the temporary seats” are used as information indicating the positions where the temporary seats are installed. The purpose of usage is detailing of the places where temporary seats are installed in a case where the temporary seats are installed without address assignment in an outdoor space or the temporary seats are installed with address assignment in an extremely large facility. Therefore, as for the installation positions of the temporary seats to be registered in the temporary seat information DB 31, the only information required is any one of the “installation addresses of the temporary seats”, the “name of the facility where the temporary seats are installed”, and the “information of the positions of the temporary seats”. Furthermore, the information accumulated in the temporary seat information DB 31 may be further associated with latitude and longitude information from information related to the address or the facility name.

The registration processing unit 34 receives a request for information necessary for temporary seat search. Examples of a search key of the information request include a temporary seat number, the date when the temporary seat information was registered, address information, and the number of temporary seats. Search keys depend on records in the temporary seat information DB 31, and are therefore, to be precise, in a range that covers elements registered in the temporary seat information DB 31. The registration processing unit 34 processes a search request from the registration device 10, retrieves the information from the temporary seat information DB 31, and transmits the information to the registration device 10.

Note that the registration device 10 may download the temporary seat information 35 to be retrieved, from the temporary seat information server 30 via the telecommunication line 40, but the present invention is not limited thereto. For example, in a case where the registration device 10 stores information corresponding to the temporary seat information 35 in the storage unit 14 of the registration device 10 in advance, the registration device 10 may use the information in the registration device 10.

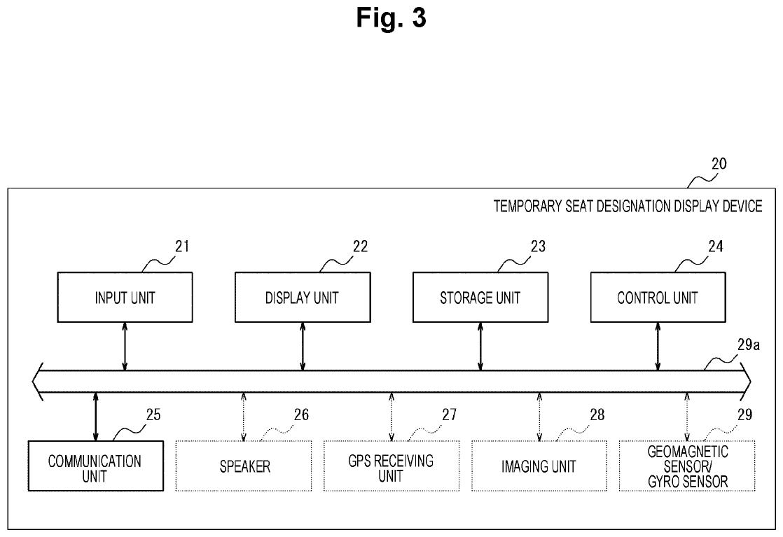

The temporary seat designation display device 20 optically projects the temporary seat numbers onto the temporary seats on the basis of the temporary seat information 35 transmitted from the registration device 10. FIG. 3 is a block diagram illustrating a configuration example of the temporary seat designation display device 20 according to the embodiment. The temporary seat designation display device 20 includes an input unit 21, a display unit 22, a storage unit 23, a control unit 24, and a communication unit 25. These functional units are connected and controlled by a bus 29a. The temporary seat designation display device 20 can be connected to the telecommunication line 40 in a wired or wireless manner.

The input unit 21 acquires, from the registration device 10, the temporary seat information 35 that includes the temporary seat installation position information indicating the positions where the temporary seats are installed, the information regarding the temporary seat numbers to be displayed on the temporary seats, the temporary seat layout information indicating layout of the temporary seats, and the use user information. The input unit 21 may be an input unit with some buttons for system settings or the like, and may act as a unit for connection with an external device in some cases.

The display unit 22 is installed above the temporary seats, and optically projects the temporary seat numbers onto the temporary seats on the basis of the temporary seat information received from the registration device 10. The display unit 22 is preferably a high-intensity projector device capable of projecting a number onto each seat.

The storage unit 23 stores the temporary seat information. The storage unit 23 is a volatile or non-volatile memory or the like including an auxiliary storage device such as a semiconductor storage device.

On the basis of the temporary seat information 35, the control unit 24 assigns the temporary seat numbers to be projected onto the temporary seats by the display unit 22. The control unit 24 is a central processing unit (CPU) or the like that performs control for executing the functions of the input unit 21, the display unit 22, the storage unit 23, and the communication unit 25 and performs various types of arithmetic processing.

The communication unit 25 enables connection to an external device via the telecommunication line 40 in a wireless or wired manner. The communication unit 25 receives the temporary seat information 35 from the registration device 10. The communication unit 25 is a device for enabling connection to the telecommunication line 40 by wireless communication such as Wi-Fi, Bluetooth (registered trademark), or LTE, and performs processing of a communication protocol.

As illustrated in FIG. 3, the temporary seat designation display device 20 may further include a speaker 26 for giving an instruction to an operator by voice, a global positioning system (GPS) receiving unit 27 for satellite positioning of the positions where the temporary seats are installed, an imaging device 28 such as a CCD camera for visually checking the positions of the temporary seats, and various types of sensors 29 such as a geomagnetic sensor and a gyro sensor for controlling the attitude of the main body of the temporary seat designation display device 20.

The temporary seat designation display device 20 is a device that optically projects temporary seat numbers onto temporary seats themselves. The temporary seat designation display device 20 includes an adjustment mechanism for projecting, for each of the installed temporary seats, a temporary seat number onto a position where the temporary seat number can be visually recognized, and is attached to a position where all the temporary seats can be viewed from above. The temporary seat designation display device 20 has a mechanism for being supported by a ceiling of a facility in a case of an indoor space, or supported by a support post or the like in a case of an outdoor space.

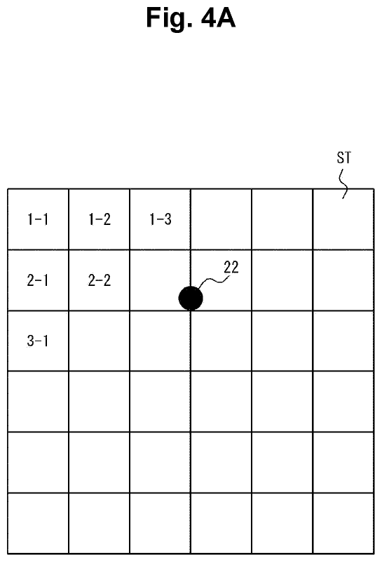

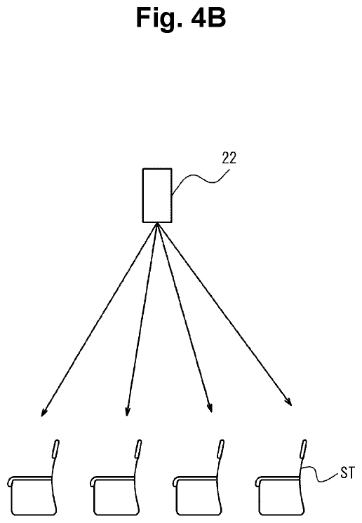

FIGS. 4A and 4B are schematic diagrams illustrating a positional relationship between the display unit 22 and installed temporary seats ST. In FIGS. 4A, 1-1, 1-2, 1-3, 2-1, 2-2, and 3-1 are temporary seat numbers. The display unit 22 is installed above the installed temporary seats so that high-intensity seat numbers are projected from the display unit 22 onto seating surfaces of temporary seats. The temporary seat designation display device 20 and the display unit 22 may be independent devices, and the display unit 22 may have a mechanism for correcting a projection direction of a gyro sensor or the like. In addition, the display unit 22 may incorporate the imaging device 28 such as a CCD camera for checking the positions of the projected seat numbers. The display unit 12 of the registration device 10 described above may have a mechanism capable of checking a video captured by the imaging device 28 incorporated in the display unit 22 on a display via the telecommunication line 40. With such a mechanism, it is possible to remotely adjust the orientation of the main body of the display unit 22 while checking the captured video.

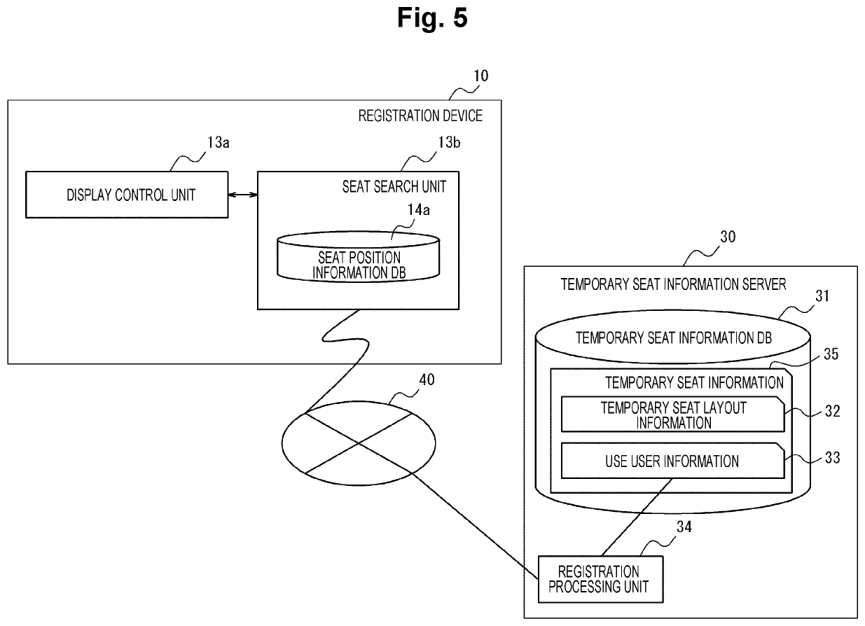

Next, operation of the number display system 1 such as search for a temporary seat will be described with reference to FIG. 5.

The registration device 10 can display temporary seat layout information (hereinafter referred to as a “seat map”), and functions as an auxiliary device for facilitating configuration of settings for the temporary seat designation display device 20. Seat map data may be held in a non-volatile manner in the storage unit 14 of the registration device 10, and in a case where connection with the telecommunication line 40 is established, it is possible to access the temporary seat information server 30 and display a seat map of a display range each time. However, in a case where seat map data is implemented in the registration device 10 in advance, seat map data that sufficiently fits in a data region in a storage region of the registration device 10 is implemented in consideration of the storage region in the storage unit 14 of the registration device 10. The seat map data allows for scale change and display of an area of a certain range.

In the configuration illustrated in FIG. 5, the registration device 10 has a function of freely changing the scale and the area of a displayed seat map by a user's operation on the input unit 11 such as a mouse or a touch panel for the displayed seat map so that the user can search for a target seat by using the seat map. In this manner, the user can perform seat search by visually find a seat map near a desired seat.

The registration device 10 may include, as the input unit 11, an interface such as a microphone for voice input or a software keyboard or a hardware keyboard for text input, thereby allowing the user to search for a seat position by text or voice.

As illustrated in FIG. 5, on the basis of temporary seat information input from the input unit 11, the seat search unit 13b of the registration device 10 accesses the temporary seat information server 30 via the telecommunication line 40 by using the information for search that has been input. Then, the seat search unit 13b acquires, as temporary seat information, the temporary seat information 35 that is temporary seat information accumulated in the temporary seat information server 30 and is associated with search information transmitted by the registration device 10. The seat search unit 13b allows the registration device 10 to obtain the temporary seat information 35 from the temporary seat information server 30 on the basis of the temporary seat information (search information) specified by the user.

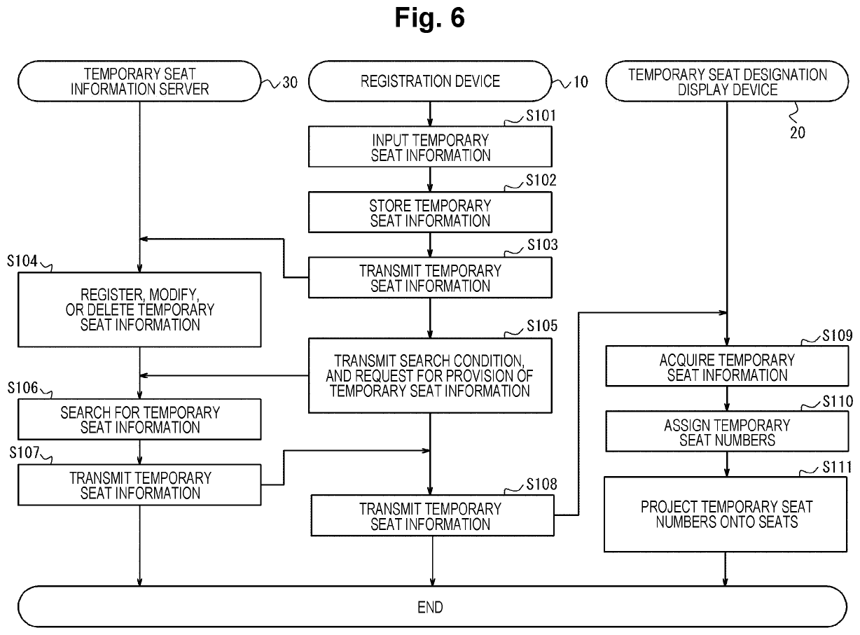

FIG. 6 is a sequence diagram illustrating an example of a number display method executed by the number display system 1 according to the embodiment.

In step S101, the input unit 11 of the registration device 10 inputs temporary seat information.

In step S102, the storage unit 14 of the registration device 10 stores the temporary seat information.

In step S103, the communication unit 15 of the registration device 10 transmits the temporary seat information to the temporary seat information server 30 via the telecommunication line 40.

In step S104, the registration processing unit 34 of the temporary seat information server 30 registers, modifies, or deletes the temporary seat information in response to a request from the registration device 10.

In step S105, the communication unit 15 of the registration device 10 transmits search information to the temporary seat information server 30, and requests for provision of the temporary seat information.

In step S106, the registration processing unit 34 of the temporary seat information server 30 searches for the temporary seat information on the basis of the transmitted search information.

In step S107, the registration processing unit 34 of the temporary seat information server 30 transmits the temporary seat information matching the search information to the registration device 10 via the telecommunication line 40.

In step S108, the communication unit 15 of the registration device 10 transmits the temporary seat information received from the temporary seat information server 30 to the temporary seat designation display device 20 via the telecommunication line 40.

In step S109, the input unit 21 of the temporary seat designation display device 20 acquires the temporary seat information.

In step S110, the control unit 24 of the temporary seat designation display device 20 assigns temporary seat numbers.

In step S111, the display unit 22 of the temporary seat designation display device 20 optically projects the temporary seat numbers onto the seats.

The number display system 1 according to the present embodiment allows seat numbers to be remotely assigned and displayed on temporary seats via a telecommunication line, and it is therefore possible to flexibly and immediately respond to the layout of seats or an increase or decrease in the number of seats.

The control unit (controller) 13 in the registration device 10 and the control unit (controller) 24 in the temporary seat designation display device 20 described above may be constituted by dedicated hardware such as an application specific integrated circuit (ASIC) or a field-programmable gate array (FPGA), may be constituted by a processor, or may be constituted by both dedicated hardware and a processor.

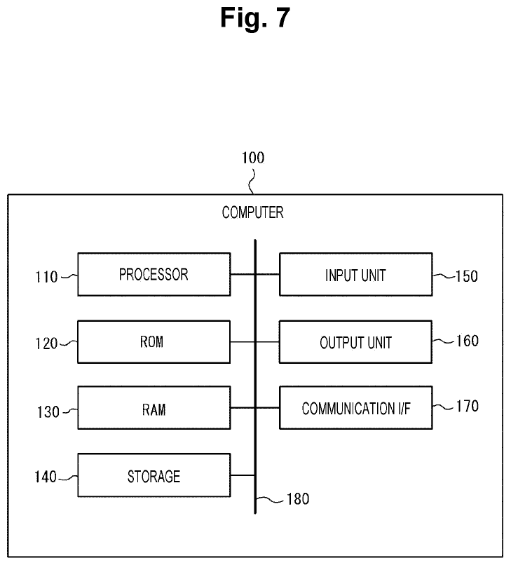

In order to cause the registration device 10 and the temporary seat designation display device 20 described above to function, it is also possible to use a computer capable of executing a program command. FIG. 7 is a block diagram illustrating a schematic configuration of a computer that functions as the registration device 10 or the temporary seat designation display device 20. Here, the computer that functions as the registration device 10 and the temporary seat designation display device 20 may be a general-purpose computer, a dedicated computer, a workstation, a personal computer (PC), an electronic note pad, or the like. The program command may be a program code, code segment, or the like for executing a necessary task.

As illustrated in FIG. 7, a computer 100 includes a processor 110, a read only memory (ROM) 120, a random access memory (RAM) 130, and a storage 140 as storage units, an input unit 150, an output unit 160, and a communication interface (I/F) 170. The components are communicably connected to each other via a bus 180. In the registration device 10 described above, the input unit 11 may be constructed as the input unit 150, the display unit 12 may be constructed as the output unit 160, the display control unit 13a and the seat search unit 13b may be configured as the processor 110, and the seat position information DB 14a may be configured as the storage 140. On the other hand, in the temporary seat designation display device 20 described above, the input unit 21 may be constructed as the input unit 150, and the display unit 22 may be constructed as the output unit 160.

The ROM 120 stores various programs and various types of data. The RAM 130 temporarily stores a program or data as a working area. The storage 140 is constituted by a hard disk drive (HDD) or a solid state drive (SSD), and stores various programs including an operating system and various types of data. In the present disclosure, a program according to the present disclosure is stored in the ROM 120 or the storage 140. The storage unit 14 of the registration device 10 and the storage unit 23 of the temporary seat designation display device 20 described above may be constructed as the ROM 120, the RAM 130, and the storage 140.

Specifically, the processor 110 is a central processing unit (CPU), a micro processing unit (MPU), a graphics processing unit (GPU), a digital signal processor (DSP), a system on a chip (SoC), or the like and may be constituted by the same or different types of plurality of processors. The processor 110 reads a program from the ROM 120 or the storage 140 and executes the program by using the RAM 130 as a working area to perform control of each of the above-described components and various types of arithmetic processing. At least some of those processing contents may be implemented by hardware.

The program may be recorded in a recording medium readable by the registration device 10 and the temporary seat designation display device 20. By using such a recording medium, the program can be installed in the registration device 10 and the temporary seat designation display device 20. Here, the recording medium on which the program is recorded may be a non-transitory recording medium. Examples of the non-transitory recording medium include, but are not limited to, a CD-ROM, a DVD-ROM, and a universal serial bus (USB) memory. The program may be downloaded from an external device via a network.

Regarding the above embodiment, the following supplements are further disclosed.

### (Supplementary Note 1)

A number display system that optically displays temporary seat numbers on temporary seats, the number display system including:
a registration device that inputs temporary seat information that includes temporary seat installation position information indicating positions where the temporary seats are installed, information regarding the temporary seat numbers to be displayed on the temporary seats, and temporary seat layout information indicating layout of the temporary seats, and transmits the temporary seat information and search information for searching for the temporary seat information;
a temporary seat information server that registers the temporary seat information transmitted from the registration device in a temporary seat information DB, searches the temporary seat information DB on the basis of the search information transmitted from the registration device, acquires the temporary seat information matching the search information, and transmits the temporary seat information to the registration device; and
a temporary seat designation display device that optically projects the temporary seat numbers onto the temporary seats on the basis of the temporary seat information transmitted from the registration device.

### (Supplementary Note 2)

A registration device including:
an input interface that inputs temporary seat information that includes temporary seat installation position information indicating positions where temporary seats are installed, information regarding temporary seat numbers to be displayed on the temporary seats, and temporary seat layout information indicating layout of the temporary seats; and
a communication interface that transmits, to a temporary seat information server, the temporary seat information and search information for searching for the temporary seat information, and receives the temporary seat information matching the search information.

### (Supplementary Note 3)

A temporary seat designation display device including a control unit that acquires temporary seat information that includes temporary seat installation position information indicating positions where temporary seats are installed, information regarding temporary seat numbers to be displayed on the temporary seats, and temporary seat layout information indicating layout of the temporary seats, and is installed above the temporary seats to optically project the temporary seat numbers onto the temporary seats.

### (Supplementary Note 4)

A number display method for optically displaying temporary seat numbers on temporary seats, the number display method including:
by a registration device,
a step of inputting temporary seat information that includes temporary seat installation position information indicating positions where the temporary seats are installed, information regarding the temporary seat numbers to be displayed on the temporary seats, and temporary seat layout information indicating layout of the temporary seats; and a step of transmitting the temporary seat information or search information for searching for the temporary seat information;
by a temporary seat information server,
a step of registering the temporary seat information transmitted from the registration device in a temporary seat information DB; and a step of searching the temporary seat information DB on the basis of the search information transmitted from the registration device, acquiring the temporary seat information matching the search information, and transmitting the temporary seat information to the registration device; and
by a temporary seat designation display device,
a step of optically projecting the temporary seat numbers onto the temporary seats on the basis of the temporary seat information transmitted from the registration device.

### (Supplementary Note 5)

A non-transitory storage medium storing a program that is executable by a computer, the non-transitory storage medium storing a program that causes the computer to function as the registration device according to Supplementary Note 2.

### (Supplementary Note 6)

A non-transitory storage medium storing a program that is executable by a computer, the non-transitory storage medium storing a program that causes the computer to function as the temporary seat designation display device according to the Supplementary Note 3.

Although the above-described embodiment has been described as a representative example, it is apparent to those skilled in the art that many modifications and substitutions can be made within the spirit and scope of the present disclosure. Therefore, it should be understood that the present invention is not limited by the above-described embodiment, and various modifications or changes can be made without departing from the scope of the claims. For example, a plurality of configuration blocks illustrated in the configuration diagrams of the embodiment can be combined into one, or one configuration block can be divided.

### REFERENCE SIGNS LIST

1 Number display system
10 Registration device
11 Input unit
12 Display unit
13 Control unit
13a Display control unit
13b Seat search unit
14 Storage unit
14a Seat position information DB
15 Communication unit
16 GPS receiving unit
17 Bus
20 Temporary seat designation display device
21 Input unit
22 Display unit
23 Storage unit
24 Control unit
25 Communication unit
26 Speaker
27 GPS receiving unit
28 Imaging unit
29 Geomagnetic sensor/gyro sensor
29a Bus
30 Temporary seat information server
31 Temporary seat information DB
32 Temporary seat layout information
33 Use user information
34 Registration processing unit
35 Temporary seat information
40 Telecommunication line (network)
100 Computer
110 Processor
120 ROM
130 RAM
140 Storage
150 Input unit
160 Output unit
170 Communication interface (I/F)
180 Bus

1. A number display system for optically displaying temporary seat numbers on temporary seats, the number display system comprising a processor configured to execute operations comprising:
receiving, as input, temporary seat information that includes temporary seat installation position information indicating positions where the temporary seats are installed, information regarding the temporary seat numbers to be displayed on the temporary seats, and temporary seat layout information indicating layout of the temporary seats;
registering, the temporary seat information in a temporary seat information database;
searching the temporary seat information database on the basis of the search information;
acquiring the temporary seat information matching the search information; and
optically projecting the temporary seat numbers onto the temporary seats on the basis of the temporary seat information.

2. A registration device comprising a processor configured to execute operations comprising:
receiving, as input, temporary seat information that includes temporary seat installation position information indicating positions where temporary seats are installed, information regarding temporary seat numbers to be displayed on the temporary seats, and temporary seat layout information indicating layout of the temporary seats; and
transmitting, to a temporary seat information server, the temporary seat information and search information for searching for the temporary seat information, and receives the temporary seat information matching the search information.

3. A temporary seat designation display device comprising a processor configured to execute operations comprising:
acquiring temporary seat information that includes temporary seat installation position information indicating positions where temporary seats are installed, information regarding temporary seat numbers to be displayed on the temporary seats, and temporary seat layout information indicating layout of the temporary seats; and
optically projecting, to a region above the temporary seats, the temporary seat numbers onto the temporary seats.

4-6. (canceled)

7. The number display system according to claim 1, wherein the temporary seats are not fixedly installed in a facility.

8. The number display system according to claim 1, wherein the optically projecting the temporary seat numbers thereby replaces affixing respective temporary seats of the temporary seats with printed labels.

9. The number display system according to claim 1, the processor further configured to execute operations comprising:
stopping, based on a predetermined condition of using the temporary seats, the optical projecting the temporary seat numbers.

10. The registration device according to 2, wherein the temporary seats are not fixedly installed in a facility.

11. The temporary seat designation display device according to claim 3, wherein the temporary seats are not fixedly installed in a facility.

12. The temporary seat designation display device according to claim 3, wherein the optically projecting the temporary seat numbers thereby replaces affixing respective temporary seats of the temporary seats with printed labels.

13. The temporary seat designation display device according to claim 3,
the processor further configured to execute operations comprising:
stopping, based on a predetermined condition of using the temporary seats, the optical projecting the temporary seat numbers.
